(19) United States
(12) Patent Application Publication
(10) Pub. No.: US 2002/0172143 A1
(43) Pub. Date: Nov. 21, 2002

(54) Limiting shelf life for limited play optical information storage media

(76) Inventors: Nabil M. Lawandy, North Kingstown, RI (US); Marianne Krieg-Kowald, Barrington, RI (US); Andrei Smuk, Providence, RI (US)

Correspondence Address: HARRINGTON & SMITH, LLP, 4 RESEARCH DRIVE, SHELTON, CT, 06484-6212, US

(21) Appl. No.: 10/016,263

(22) Filed: Dec. 10, 2001

Related U.S. Application Data
(60) Provisional application No. 60/254,608, filed on Dec. 11, 2000.

(51) Int. Cl. G11B 7/24

(52) U.S. Cl. 369/292; 430/270.15; 430/945; 428/64.4

(57) ABSTRACT

An optically readable media and packaging therefor, where the media includes a material that over time undergoes at least one of a chemical change or a physical change to render unreadable the optically readable media. The media is sealed within the packaging with a source of a chemical compound that inhibits the change, and the media is also sealed within the packaging with a getter of the chemical compound that over time absorbs said chemical compound, or which a substance that over time renders unreactive a reactive chemical compound. In a further embodiment the media is sealed within the packaging with a getter of a chemical compound that promotes the change. In this case the getter absorbs the chemical compound until saturated with the chemical compound, after which the concentration of the chemical compound increases until the media is rendered unreadable. As non-limiting examples, the chemical compound may be NMP, DMF, acetone, or HCl. In another embodiment the media further includes a diffusion barrier that inhibits but does not prevent the chemical compound from reaching a layer of the media that over time undergoes at least one of a chemical change or a physical change to render unreadable the optically readable media, while in another embodiment the source of the chemical compound includes the diffusion barrier. In a further embodiment the media includes a first layer that over time undergoes the at least one of a chemical change or a physical change, a second layer that contains the source of a chemical compound that promotes the change, and the diffusion barrier is interposed between the first layer and the second layer.

### FIELD OF THE INVENTION

This invention relates to optical disks of all types, including for example digital disks such as compact disks (CD's), digital video disks (DVD's), CDROM's, and the like.

### BACKGROUND OF THE INVENTION

Conventional optical disks have reached widespread acceptance as a low-cost, reliable storage medium for digital information including music, video, and data. One of the traditional advantages of optical disks is their long life. However, in some applications, the long life of the conventional optical disk may represent a disadvantage. For example, it may be advantageous to eliminates the need for the return of an optical disk at the end of a rental period. It may also be advantageous to limit the life of an optical disk to prevent a user from making an unlimited number of copies, or to prevent a user from distributing the disk to others for an unlimited time period.

U.S. Pat. No. 5,815,484 discloses an optical disk having a reflective metallic layer with a plurality of data structures (provided in the form of pits and lands) and a compound that reacts with oxygen that is superimposed over at least some of the data structures for inhibiting reading of the information.

Commonly assigned U.S. Pat. No. 6,011,772 discloses a read inhibit mechanism that may also use a barrier layer. For example, the removal of the barrier layer enhances the action of a reading-inhibit agent to prevent machine reading of information encoding features on the optical disk. The reading-inhibit agent may also be activated by exposure to optical radiation, or by rotation of the disk.

In addition to the foregoing limited play or readout inhibiting uses it may also be advantageous to provide a disk with a limited shelf life, for example, to prevent users from using old versions of information or software on the disk.

### OBJECTS OF THE INVENTION

It is a first object and advantage of this invention to provide an improved system and method for permanently limiting the readability of a media, such as an optically readable media, examples of which include, but are not limited to, a laser disk, a compact disk (CD), or a digital video disk (DVD).

It is a second object and advantage of this invention to provide an improved system and method to render an optically readable media permanently unreadable while the media is stored in a sealed package.

### SUMMARY OF THE INVENTION

This invention provides a mechanism to limit the period during which an optically readable disk, having a read inhibit mechanism, can be stored prior to use. That is, the shelf life of the optical disk is intentionally limited to be less than some maximum desired period, such as some number of weeks or months.

An optically readable media and packaging therefor, where the media includes a material that over time undergoes at least one of a chemical change or a physical change to render unreadable the optically readable media. The media is sealed within the packaging with a source of a chemical compound that inhibits the change, and the media is also sealed within the packaging with a getter of the chemical compound that over time absorbs the chemical compound, or which a substance that over time renders unreactive a reactive chemical compound.

In a further embodiment the media is sealed within the packaging with a getter of a chemical compound that promotes the change. In this case the getter absorbs the chemical compound until saturated with the chemical compound, after which the concentration of the chemical compound increases until the media is rendered unreadable. As non-limiting examples, the chemical compound may be NMP, DMF, acetone, or HCl.

In another embodiment the media further includes a diffusion barrier that inhibits, but does not prevent, the chemical compound from reaching a layer of the media that over time undergoes the at least one of the chemical change or the physical change to render the media unreadable, while in another embodiment the source of the chemical compound includes the diffusion barrier. In a further embodiment the media includes a first layer that over time undergoes the at least one of the chemical change or the physical change, a second layer that contains a source of a chemical compound that promotes the change, and the diffusion barrier that is interposed between the first layer and the second layer. As before, the diffusion layer inhibits, but does not prevent, the chemical compound from reaching the first layer.

Various methods for limiting the usable life of an optically readable media are also described.

### BRIEF DESCRIPTION OF THE DRAWINGS

The above set forth and other features of the invention are made more apparent in the ensuing Detailed Description of the Invention when read in conjunction with the attached Drawing, wherein:

FIG. 1 is a cross-sectional view of an optically readable media, also referred to herein for convenience as a disk, that includes a readout inhibiting layer;

FIGS. 2, 3, 4 and 5 illustrate various embodiments of techniques for packaging the disk so as to limit the shelf life of the disk;

FIG. 6 is a cross-sectional view of an embodiment of the disk wherein an agent that limits the optical readable period of the disk is included as a layer on the disk;

FIGS. 7, 8, 9, 10 and 11 illustrate various embodiments of diffusion barriers that are provided as a part of the disk so as to control a rate at which the disk is transformed from an optically readable state to an optically unreadable state; and

FIG. 12 shows an embodiment wherein the diffusion barrier is associated with a source of a chemical compound that interacts with the disk to limit the readable period of the disk.

### DETAILED DESCRIPTION OF THE INVENTION

The teachings of this invention can be implemented in a number of different ways, and the following discussion describes a number of suitable embodiments of the invention. These embodiments are intended as examples only, and not as an exhaustive representation of all forms that the invention can take. Generally speaking, the embodiments discussed below can be described as including a disk that becomes optically unreadable after a period of time, even if the disk remains sealed within in its original packaging. In other words, various methods are described for limiting the usable life of an optically readable media, even if the media is not removed from its original packaging.

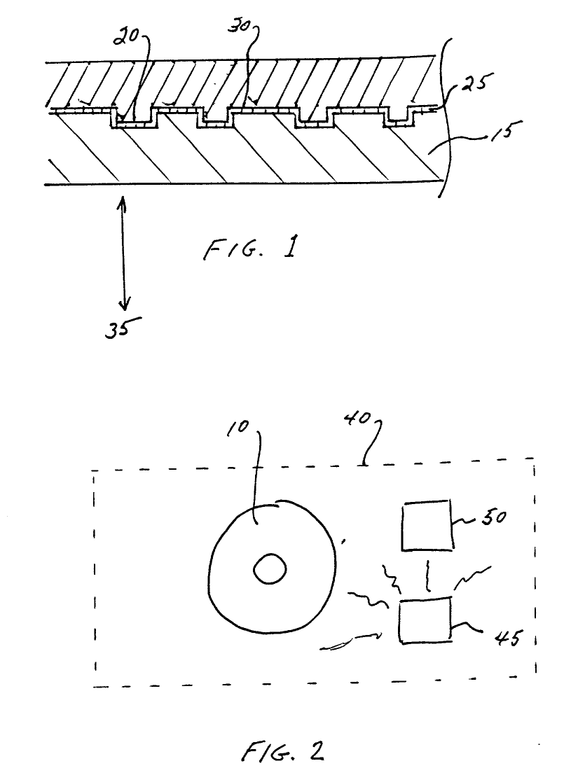

FIG. 1 shows a simplified cross-section (not to scale) of an optical disk 10, also referred to herein generally as one embodiment of an optically readable media. The disk 10 includes a substrate 15 that is formed with an array of information-encoding features such as pits 20. The surface defining the information-encoding features 20 is covered with a reflective layer 25, which may be, for example, formed of aluminum. The reflective layer 25 is in turn covered with a protective layer 30 which protects the reflective layer 25 from oxidation and physical damage. A reading beam 35 is incident on the surface of the substrate 15 opposite the information-encoding features 20. This reading beam passes through the substrate 15, is reflected by the reflective layer 25, and then passes out through the substrate 15 for detection. As used herein, the term “information-encoding features” is intended broadly to encompass the widest possible range of such features, regardless of the particular encoding mechanism or reading beam interaction mechanism that is used.

In a first embodiment, shown in FIG. 2, the disk 10 is present in an environment 40 with a substance 45 that maintains the readability of the disk. An absorbing substance, 50 also known as a getter or scavenger, is included in the environment 40 and the getter 50 absorbs the maintaining substance 45 from the environment over time. When the maintaining substance 45 in the environment decreases to a certain level, the disk 10 is rendered unreadable. The action of the getter 50 in absorbing the maintaining substance 45 maybe considered as removing the substance 45 from the environment of the disk 10.

As an example, the disk 10 may already include a mechanism for rendering it unreadable by evaporation of a substance. An example of such a mechanism includes using the class of lactone dyes that are used in carbonless copy papers. The colorless lactone form of the dye can be caused to “open” to the colored cationic form of the dye by absorption onto an acidic clay or other acidic substrate, by lowering of the pH of the lactone in solution, or by changing the polarity of the solvent in which the lactone is dissolved. Polymers derived from phenol and formaldehyde have been shown to be effective in causing the opening of a lactone dye (see U.S. Pat. No. 4,578,690), presumably due to the acidic nature of the phenolic component. This mechanism of using a mixture of solvents, one relatively volatile and a second one which is relatively non-volatile, operates such that the less volatile solvent remains upon evaporation of the more volatile solvent, and the mixture remains colorless until the less volatile solvent evaporates over a period of time.

By experimentation it has been determined that NMP (N-methyl pyrrolidinone) is one substance that is suitable as a less volatile solvent. The mechanism for rendering the disk unreadable in this example includes applying a coating to the disk, for example, a solution including poly-p-(hydroxystyrene), ethanol, crystal violet lactone, and NMP. The disk is then enclosed in an environment with additional NMP to form an NMP saturated environment. A getter or scavenger is included in the environment that absorbs the NMP from the environment over time. When the NMP becomes absorbed, the disk undergoes a color change as described above, rendering it unreadable. The absorption of the NMP can be controlled such that the color change occurs at a predictable time period after the disk is enclosed in the environment.

In another example the scattering of light rather than absorbance can also be used to attenuate an optical signal. An evaporative method to cause increased scattering can be achieved by mixing a polymer with a solid where there is a mismatch between the refractive indexes of the two materials, and then adding a solvent for the polymer which adjusts the refractive index of the polymer-solvent mixture to match that of the solid. under these conditions the mixture is non-scattering or poorly scattering since there is a refractive index match between the polymer-solvent pair and the solid. However, slow evaporation of the solvent causes a mismatch between the remaining polymer and solid and, therefore, the scattering increases. An example coating includes a solution of cellulose acetate butyrate (CAB, Mw=70,000, 13.5% acetyl, 37.5% butyryl, n=1.46) in ethyl acetate. Added to this solution is silica gel (70-230 mesh, n about 1.50) and benzyl alcohol (n about 1.54). A coating of this mixture is applied to the disk and the ethyl acetate is allowed to evaporate to provide an optically clear, transparent film. The disk is then enclosed in an environment with a getter that absorbs one of the components of the mixture over time to cause the disk to become unreadable.

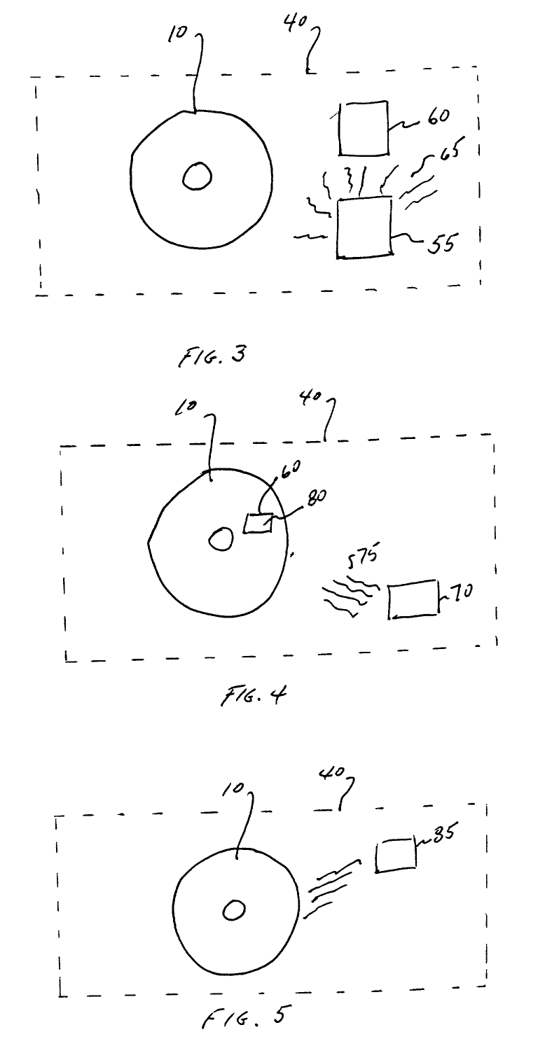

In another embodiment, as shown in FIG. 3, the disk 10 is present in the environment 40 with a source 55 that emits a substance 65 that directly or indirectly renders the disk 10 unreadable. A getter 60 is again included in the environment and absorbs the substance 65, causing the concentration of the substance 65 in the environment 40 to be maintained at a low level which does not affect the disk. The getter material is selected such that at a certain time it becomes saturated and no longer absorbs the substance 65. The concentration of the substance 65 then increases to a level that renders the disk 10 unreadable.

In still another embodiment, shown in FIG. 4, the disk 10 is again present in the environment 40 with a source 70 that emits a substance 75 that directly or indirectly renders the disk 10 unreadable. The getter 60 absorbs the substance 75, such that the getter absorbed substance 80 is positioned close to an area of the disk 10. As the concentration of the substance 80 in the getter material increases, it renders the disk 10 unreadable.

In the two embodiments just mentioned and shown by FIGS. 3 and 4, the substance 65, 75, 80 that renders the disk 10 unreadable could include dimethyl formamide (DMF). The compatibility of DMF with various substances is shown in the Table A found in the Appendix to this patent application. Of the various materials listed in Table A, the materials that exhibit the “severe” or “fair” effect are most suitable for use in the present invention with DMF. For example, a polycarbonate layer of a disk in the presence of a certain concentration of DMF would exhibit a severe effect which could include swelling, roughness, and distortion. Such changes in the surface topology of a disk would render the disk unreadable according to the teachings of the present invention.

Another substance suitable for rendering the disk 10 unreadable in the two embodiments shown in FIGS. 3 and 4 is NMP. NMP in high concentrations affects polymers, causing crazing and other effects that render a polymer material, for example a polycarbonate layer on a disk, optically unsuitable, causing the disk to become unreadable.

Other substances suitable for rendering the disk 10 unreadable include acetone and hydrochloric acid (HCl). Acetone also acts on polymers including polycarbonate and other like materials to cause crazing and other effects that render one or more layers of the disk optically unsuitable, causing the disk 10 to become unreadable. HCl also reacts with various materials to affect their optical properties and, in particular, will react with the reflective layer 30 of the disk 10, causing corrosion which affects the reflectivity of the disk, making it unreadable.

Examples of suitable getter material include irreversible solid solutions in solid polymer, for example, PMMA in pellet, powder, or other solid form, SiO₂ gel and activated charcoal. These and similar types of materials can be inserted into the packaging of the disk 10, for example, placed in a bag containing the disk 10. These materials could also be included as a part of a layer on the disk 10, or could be incorporated as part of the packaging itself. For example, the packaging could be manufactured from a suitable getter material.

In another embodiment of the invention, a second color forming process that operates slowly over a period of time is used to disable reading of the disk. Examples of agents or combinations of agents that could be used to cause such a color forming process include oxygen (O₂) and reduced dyes, or other agents or combinations of agents that cause color formation. Other agents or combinations of agents could be used that cause oxidation, corrosion, rusting, or otherwise degrade the readability of the disk.

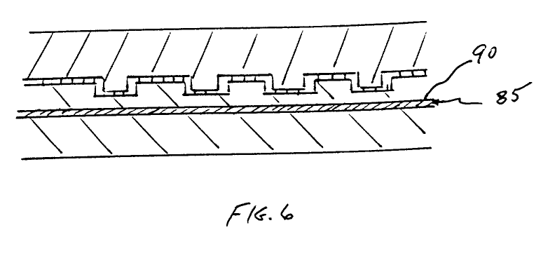

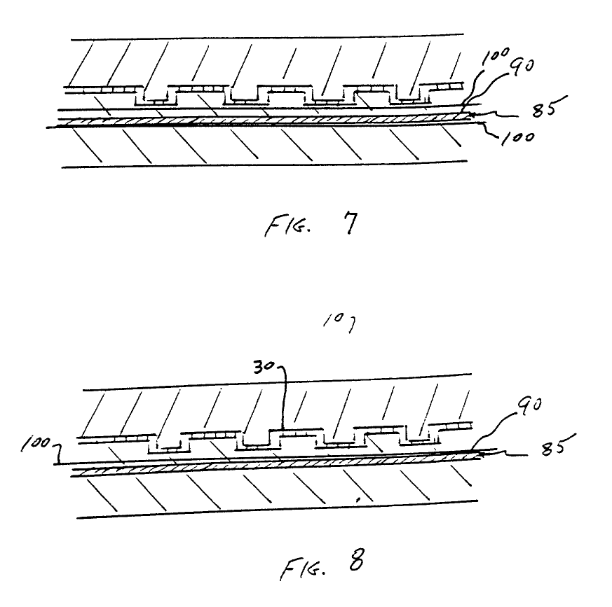

FIG. 5 shows another embodiment of the invention, where an agent or combination of agents 85 are placed in the disk's environment 40 that degrade, or attack the disk 10 and cause the disk to become unreadable over time. For example, such an agent or combination of agents 85 could be included in the packaging for a disk 10, or could be included in a layer on the disk 10 as shown in FIG. 6. One method of controlling the reaction of the agent with the disk could be to control the diffusion of the agent onto the disk's surface or through the disk. This diffusion rate can be controlled by providing a diffusion barrier 100 with known diffusion characteristics for the particular agent or combination of agents 85. One method of controlling the diffusion rate is to adjust the thickness of the diffusion barrier. Various embodiments of the diffusion barrier are shown in FIGS. 7-11.

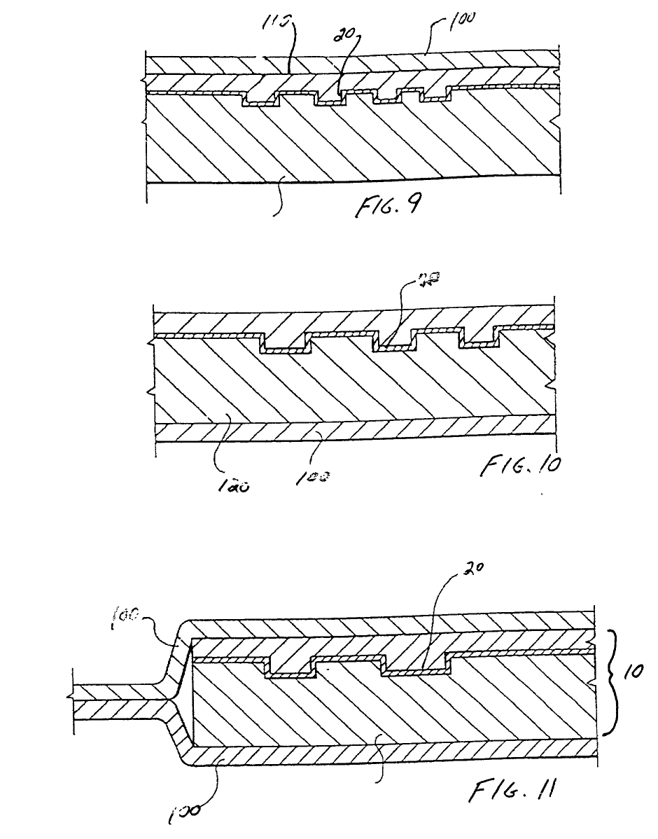

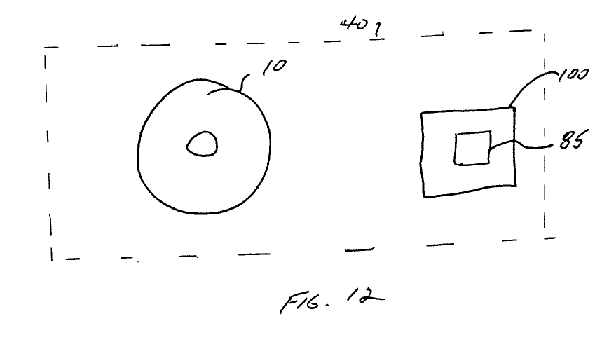

In the embodiment of FIG. 7, the diffusion barriers 100 surround the layer 90 comprising the agent or combination of agents 85. In FIG. 8, the diffusion barrier 100 is interposed between the agent carrying layer 90 and the reflective layer 30, thus controlling the diffusion of the agent 85 in the direction f the reflective layer 30. In FIG. 9, the diffusion barrier 100 is releasably secured (as for example with a suitable adhesive) adjacent the surface of the optical disk 110 that carries the information-encoding features 20. In the embodiment of FIG. 10, the diffusion barrier 100 is releasably secured to the surface of the disk 120 opposite the surface that carries the information-encoding features 22. As shown in FIG. 11, the diffusion barrier 100 is formed as a closed package which completely seals the optical disk 10 from contact with ambient oxygen and moisture.

FIG. 12 shows an embodiment where the agent 85 is encapsulated by the diffusion barrier 100 and placed in the disk's environment 40. The diffusion barrier could also be a layer or substance that is presently part of the disk, thus requiring no additional layers or added materials. Agents suitable for use in this embodiment include those that react with polymers, for example, acetone, NMP, and DMF mentioned above, and those that cause corrosion or oxidation of the reflective layer, such as HCl, also mentioned above.

It should be understood that the above described embodiments of the invention may be used singularly or in any combination in order to provide the disk 10, or an optically readable media in general, with a limited shelf life. It is further within the scope of these teachings to provide a first substance that promotes the operation of a mechanism that renders the media unreadable, and a second substance that operates, at least for a period of time, to neutralize the first substance. In this case, after the passage time the first substance is no longer neutralized and thereafter promotes the operation of the mechanism that renders the media unreadable.

Thus, while the invention has been particularly shown and described with respect to preferred embodiments thereof, it will be understood by those skilled in the art that changes in form and details maybe made therein without departing from the scope of the invention.

### Appendix

### Page 1 of 1

TABLE A
Chemical Compatibility Results for Dimethyl Formamide

| | |
|---|---|
| ABS plastic | D-Severe Effect |
| Acetal (Delrin ®) | D-Severe Effect |
| Buna N (Nitrile) | D-Severe Effect |
| CPVC | D-Severe Effect |
| EPDM | B-Good |
| Epoxy | D-Severe Effect |
| Hypalon ® | D-Severe Effect |
| Kel-F ® | A-Excellent |
| LDPE | A-Excellent |
| Natural rubber | C-Fair |
| Neoprene | D-Severe Effect |
| NORYL ® | D-Severe Effect |
| Nylon | A-Excellent |
| Polycarbonate | D-Severe Effect |
| Polypropylene | A-Excellent |
| PPS (Ryton ®) | A-Excellent |
| PTFE (Teflon ®) | A-Excellent |
| PVC | D-Severe Effect |
| PVDF (Kynar ®) | D-Severe Effect |
| Silicone | C-Fair |
| Tygon ® | D-Severe Effect |
| Viton ® | C-Fair |

Ratings - Chemical Effect:
A = Excellent
B = Good (Minor Effect, slight corrosion or discoloration)
C = Fair (Moderate Effect, not recommended for continuous use. Softening, loss of strength, swelling may occur)
D = Severe Effect (Not recommended for ANY use)

What is claimed is:

1. An optically readable media and packaging therefor, said media comprising a material that over time undergoes at least one of a chemical change or a physical change to render unreadable the optically readable media, said media being sealed within said packaging with a source of a chemical compound that inhibits said change, said media further being sealed within said packaging with a getter of said chemical compound that over time absorbs said chemical compound.

2. An optically readable media and packaging therefor, said media comprising a material that over time undergoes at least one of a chemical change or a physical change to render unreadable the optically readable media, said media being sealed within said packaging with a source of a reactive chemical compound that inhibits said change, said media further being sealed within said packaging with a substance that over time renders unreactive said reactive chemical compound.

3. An optically readable media and packaging therefor, said media comprising a material that over time undergoes at least one of a chemical change or a physical change to render unreadable the optically readable media, said media being sealed within said packaging with a source of a chemical compound that promotes said change, said media further being sealed within said packaging with a getter of said chemical compound that absorbs said chemical compound until saturated with said chemical compound, after which the concentration of said chemical compound increases until the media is rendered unreadable.

4. An optically readable media as in claim 3, wherein said chemical compound is comprised of NMP.

5. An optically readable media as in claim 3, wherein said chemical compound is comprised of DMF.

6. An optically readable media as in claim 3, wherein said chemical compound is comprised of acetone.

7. An optically readable media as in claim 3, wherein said chemical compound is comprised of HCl.

8. An optically readable media and packaging therefor, said media comprising a layer that over time undergoes at least one of a chemical change or a physical change to render unreadable the optically readable media, said media being sealed within said packaging with a source of a chemical compound that promotes said change, said media further comprising a diffusion barrier that inhibits, but does not prevent, said chemical compound from reaching said layer.

9. An optically readable media and packaging therefor, said media comprising a layer that over time undergoes at least one of a chemical change or a physical change to render unreadable the optically readable media, said media being sealed within said packaging with a source of a chemical compound that promotes said change, said source comprising a diffusion barrier that inhibits, but does not prevent, said chemical compound from reaching said layer.

10. An optically readable media, said media comprising a first layer that over time undergoes at least one of a chemical change or a physical change to render unreadable the optically readable media, said media comprising a second layer that contains a source of a chemical compound that promotes said change, said media further comprising a diffusion barrier that is interposed between said first layer and said second layer that inhibits, but does not prevent, said chemical compound from reaching said first layer.

11. A method for limiting the usable life of an optically readable media, comprising:
providing an optically readable media that comprises a material that over time undergoes at least one of a chemical change or a physical change to render unreadable the optically readable media; and
sealing said media within a package with a source of a chemical compound that inhibits said change and with a getter of said chemical compound that over time absorbs said chemical compound.

12. A method for limiting the usable life of an optically readable media, comprising:
providing an optically readable media that comprises a material that over time undergoes at least one of a chemical change or a physical change to render unreadable the optically readable media; and
sealing said media within a package with a source of a chemical compound that inhibits said change and with a getter of said chemical compound that over time renders unreactive said chemical compound.

13. A method for limiting the usable life of an optically readable media, comprising:
providing an optically readable media that comprises a material that over time undergoes at least one of a chemical change or a physical change to render unreadable the optically readable media; and
sealing said media within a package with a source of a chemical compound that promotes said change and with a getter of said chemical compound that over time absorbs said chemical compound until saturated with said chemical compound, after which the concentration of said chemical compound increases until the media is rendered unreadable.

14. A method as in claim 13, wherein said chemical compound is comprised of NMP.

15. A method as in claim 13, wherein said chemical compound is comprised of DMF.

16. A method as in claim 13, wherein said chemical compound is comprised of acetone.

17. A method as in claim 13, wherein said chemical compound is comprised of HCl.

18. A method for limiting the usable life of an optically readable media, comprising:
providing an optically readable media that comprises a material that over time undergoes at least one of a chemical change or a physical change to render unreadable the optically readable media; and
sealing said media within a package with a source of a chemical compound that promotes said change and with a diffusion barrier that inhibits, but does not prevent, said chemical compound from reaching said layer.

19. A method as in claim 18, wherein said diffusion barrier comprises a part of said media.

20. A method as in claim 18, wherein said diffusion barrier comprises a part of said source.

21. A method as in claim 18, wherein said diffusion barrier and said source both comprise a part of said media.

22. An optically readable media and packaging therefor, said media comprising a material that over time undergoes at least one of a chemical change or a physical change to render unreadable the optically readable media, said media being sealed within said packaging with a source of a chemical compound that promotes said change, said packaging comprising a getter of said chemical compound.
